(19) United States
(12) Patent Application Publication
(10) Pub. No.: US 2014/0324930 A1
(43) Pub. Date: Oct. 30, 2014

(54) SYSTEM AND METHOD FOR SYNCHRONIZED FILE EXECUTION ACROSS MULTIPLE INTERNET PROTOCOL DEVICES

(71) Applicant: SpeakerBlast Technologies, Inc., Joppa, MD (US)

(72) Inventors: Ryan P. Spahn, Joppa, MD (US); Matthew H. Tyree, Watsonville, CA (US)

(73) Assignee: SpeakerBlast Technologies, Inc., Joppa, MD (US)

(21) Appl. No.: 14/264,616

(22) Filed: Apr. 29, 2014

Related U.S. Application Data
(60) Provisional application No. 61/817,299, filed on Apr. 29, 2013.

(51) Int. Cl. G06F 17/30

(52) U.S. Cl. CPC G06F 17/30194
USPC 707/827

(57) ABSTRACT

A method of synchronizing the execution of a data file by one or more network accessible devices is provided. The method comprises the steps of uploading a data file identifier and a predetermined execution time via a network server to a database. The data file identifier and associated instructions for executing a data file associated with the data file identifier are downloaded the network server from the database onto one or more network accessible devices. The internal clock of the one or more network accessible devices are synchronized to an internal clock of the server. The data file is executed on each of the one or more network accessible devices at the predetermined execution time.

### CROSS-REFERENCE TO RELATED APPLICATIONS

This application claims priority under 35 U.S.C. §119(e) to Provisional Patent Application Ser. No. 61/817,299 entitled “SYSTEM AND METHOD FOR SYNCHRONIZED FILE EXECUTION ACROSS MULTIPLE INTERNET PROTOCOL DEVICES” filed Apr. 29, 2013, the subject matter thereof incorporated by reference in its entirety.

### FIELD OF THE INVENTION

The present disclosure relates generally to systems and methods for accurately synchronizing the execution of data files, for example audio files, across multiple network accessible devices, including internet protocol (IP) devices.

### SUMMARY

In one embodiment of the present disclosure, a method for executing a data file, such as an audio or video file, in unison across multiple network devices is provided. The method may include the steps of uploading the data file via a network-accessible server to a database, along with a predetermined desired (target) file execution time. These steps may be performed via a first network device running, for example, a web-based application. Using this or another application, one or more additional network devices may download the data file and predetermined execution time via the server from the database, as well as a set of instructions for executing the data file. These instructions may include instructions for synchronizing an internal clock of the one or more network devices to an internal clock of another device (e.g. the server). Once synchronized, each network device will execute the instructions (e.g. play the audio file) at the predetermined execution time. Embodiments of the present disclosure may be useful, for example, in a conference setting, wherein the application may be used to eliminate the need for a public address (PA) system, or other means of producing amplified audio from a single source at a volume sufficient to be heard by all those present. Embodiments may also be used for entertainment purposes, such as at a social event, wherein a plurality of users may play an audio or video file on separate network devices in unison without the need for additional wide-spread audio or video equipment.

In another embodiment, a method of synchronizing the execution of a data file by one or more network accessible devices is provided. The method comprises the steps of uploading a data file identifier and a predetermined execution time via a network server to a database. The data file identifier and associated instructions for executing a data file associated with the data file identifier are downloaded to the network server from the database onto one or more network accessible devices. The internal clock of the one or more network accessible devices are synchronized to an internal clock of the server. The data file is executed on each of the one or more network accessible devices at the predetermined execution time.

A non-transitory computer readable medium containing program instructions is also provided. The program instructions cause a network accessible computer to perform a method including the steps of: downloading a data file identifier and associated instructions for execution thereof via a network server from a database onto the computer; synchronizing the internal clock of the computer to an internal clock of the server; and executing the data file on the computer at a predetermined time indicated by the downloaded instructions.

### BRIEF DESCRIPTION OF THE DRAWINGS

FIG. 1 is a process diagram illustrating exemplary steps for creating a synchronized session according to an embodiment of the present disclosure.

FIG. 2 is a process diagram illustrating exemplary steps for loading a created session onto a first client device according to an embodiment of the present disclosure.

FIG. 3 is a process diagram illustrating exemplary steps for a first client to invite participants to the session according to an embodiment of the present disclosure.

FIG. 4 is a process diagram illustrating exemplary steps for loading a created session onto participants' devices according to an embodiment of the present disclosure.

FIG. 5 is a process diagram illustrating the function of the synchronized session application according to an embodiment of the present disclosure.

FIG. 6 is a process diagram illustrating an exemplary synchronization process used by the client and participant devices according to an embodiment of the present disclosure.

FIG. 7 is a block diagram illustrating a system for implementing embodiments of the present disclosure.

### DETAILED DESCRIPTION

It is to be understood that the figures and descriptions of the present invention have been simplified to illustrate elements that are relevant for a clear understanding of the present invention, while eliminating, for purposes of clarity, many other elements found computing systems, including computing systems communicating with one or more servers via a local or internet network connection, as well as computer systems running native or web-based applications or other software. However, because such elements are well known in the art, and because they do not facilitate a better understanding of the present invention, a discussion of such elements is not provided herein. The disclosure herein is directed to all such variations and modifications known to those skilled in the art.

In the following detailed description, reference is made to the accompanying drawings that show, by way of illustration, specific embodiments in which the invention may be practiced. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout several views.

As set forth above, embodiments of the present disclosure include methods, such as website application-based processes, for facilitating the execution of a data file in unison across multiple network or IP devices. Throughout the present disclosure, the term “session” or “synchronized session” may be used to describe a given data file as well the broadcast information associated therewith (file name, desired execution time, etc.).

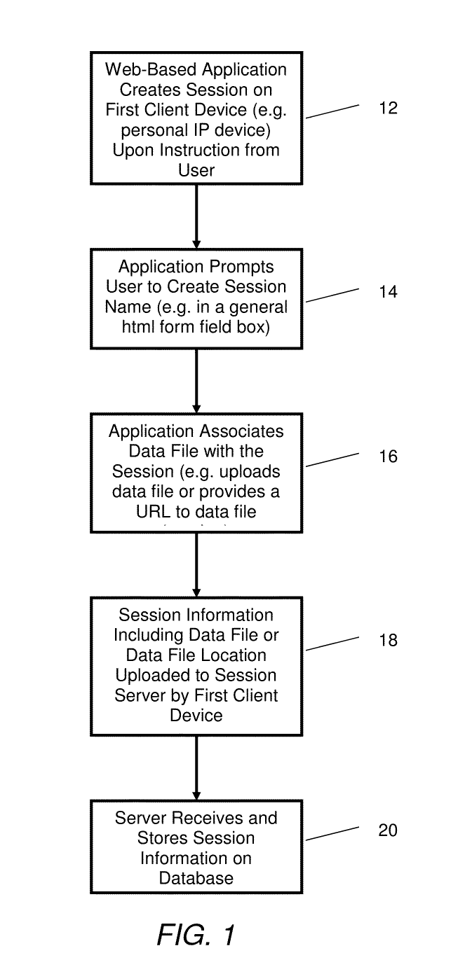

Referring generally to FIG. 1, a method illustrating the initial creation of a synchronized session is provided. In one embodiment, the method includes the creation of a session by a web-based application in response to a user request received via a first IP or client device (step 12). The application may prompt a user to create a session name, which may be entered through, for example, a general html form field box generated by the application (step 14). The application associates a data file, such as an audio or video file, with the session (step 16) in response to a user instruction. In one exemplary embodiment, the application upload a user-identified data file, such as an MP3 audio file, stored on either the first IP device or stored at another (remote) location. In other embodiments, the user may only identify and enter the location of a data file (e.g. a URL or other data file identifier). In still other embodiments, the user may perform a web search initiated through the application for locating a desired data file and either upload the data file from the search results, or store the location of a data file (e.g. a URL) revealed from the search.

Once a data file, data file location, or other data file identifier has been associated with the named session, this information is transmitted over a network connection (e.g. an internet connection or a local area network by way of non-limiting example) by the first IP device to a session server and an associated session database (step 18). The server receives the session data, and creates and stores a record of the session, including the session name and the associated data file, location thereof, or other data file identifier in the database (step 20). While this initial session creation may be described as being facilitated via a web-based application, the initial session creation according to embodiments of the present disclosure may also be accomplished via other mechanisms, such as via a native application running on, for example, the first IP device.

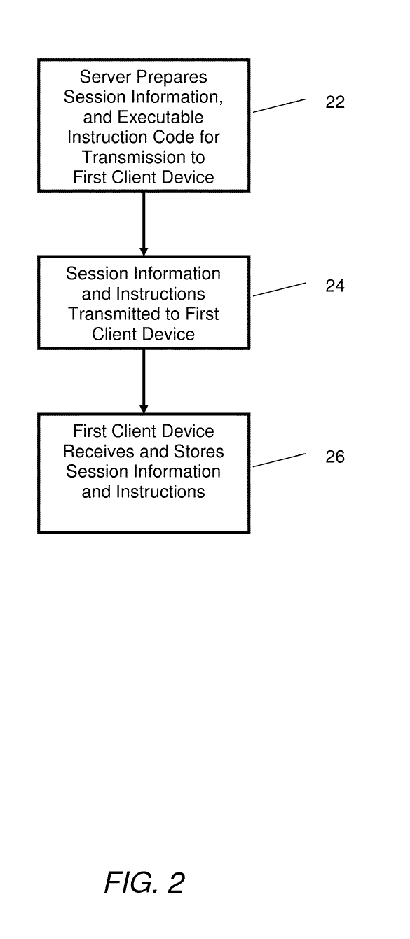

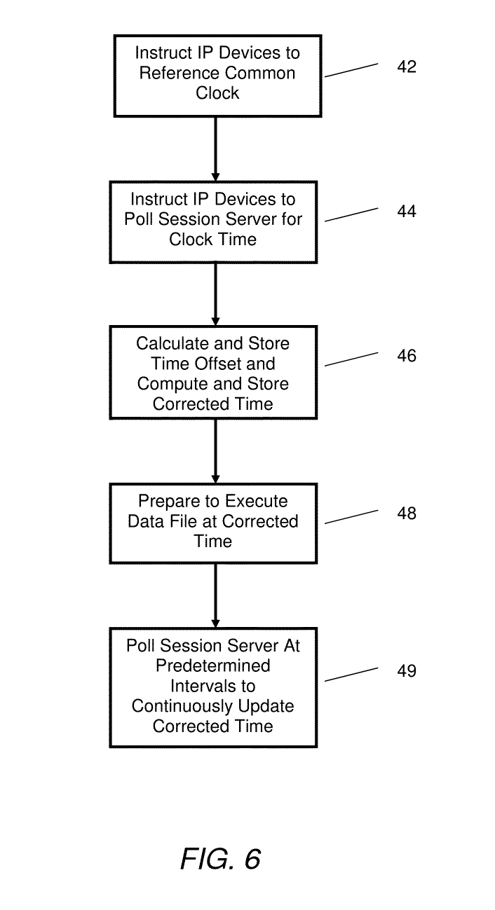

Referring now to FIG. 2, should the session creator wish to take part in the synchronized session via the first IP device, the session information is downloaded to the IP device. In particular, once a created session is received by the server and stored in the database, the server prepares the received data (e.g. session name and data file information), executable code including web application code and instructions for playing the data file at a predetermined time, as well as images or graphics associated with the application, for transmission to the first IP device in step 22. In step 24, a network connection (e.g. an internet connection) is formed between the first IP device and the server. Finally in step 26, the first IP device receives the executable code, related images and/or graphics, the session name and the data file (or location thereof) associated with a session from the server. This data will be stored on the first IP device. Upon receipt of the transmission, a new webpage may be created/loaded onto the first IP device. The URL of the new page may be identified by the session name. The first IP device then loads the images and the web application code. Additionally, as will be set forth in greater detail with respect to FIG. 6, code configured to provide time-synchronization is also loaded onto the first IP device. Finally, the previously-uploaded data file or the audio file from a third party website is downloaded and stored onto the first IP device. During the downloading of these assets, a “loading” graphic may be generated and displayed on the first IP device, followed by a subsequent “Check in” button, which is actuated by a user to confirm his or her desire to participate in the session.

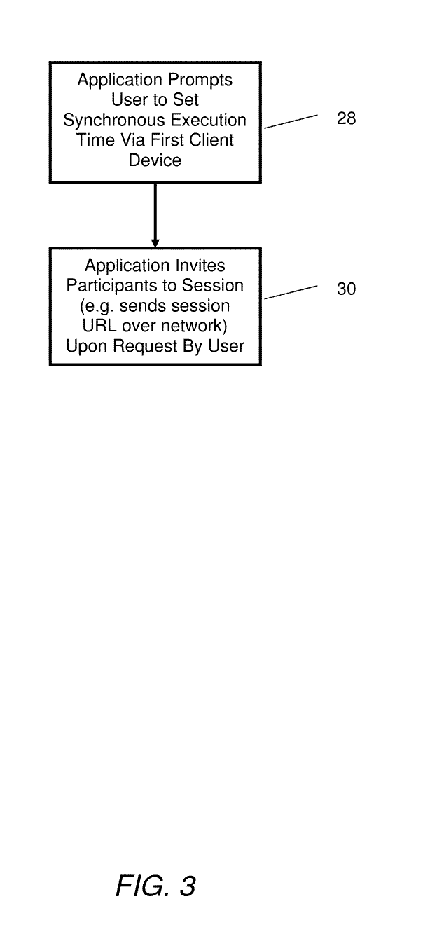

As set forth in FIG. 3, once the session information and associated software has been loaded onto the first IP device, and, for example, the “Check in” button has been actuated, the user may be instructed to set a desired time for the synchronous data file execution (e.g. the playing of an audio file) in step 28. This may be achieved via, for example, a drop-down menu or other suitable interface of the software application. In other embodiments, this predetermined execution time may also be obtained during the initial session creation described above with respect to FIG. 1. In step 30, after a user has set a desired time for the execution of the data file, the application may invite additional participants to the session upon request by the user. The invitations may be achieved by, for example, sending a URL linking to the created session over a digital communication network (e.g. email), or by any other means, such as verbal or written instructions provided to potential participants.

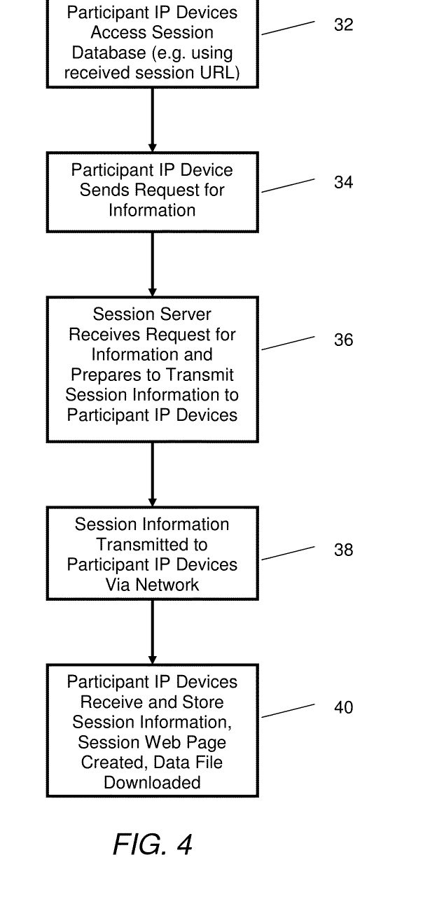

FIG. 4 illustrates exemplary steps for loading a session onto one or more participant IP devices. It should be understood that these steps may be substantially the same as those set forth above with loading a session onto the session creator's IP device. For example, in step 32, each participant accesses the session database by, for example, clicking the URL received from the session creator, or by visiting the website as directed by the session creator. This action sends a request for information about the URL to the session server and database from each participant's IP device over, for example, a local network or an internet connection in step 34. In step 36, the session server and database receive the information requested for the URL and prepare to transmit to the participants' devices the images, executable code, and the uploaded data file and/or the URL of the data file on the web for the session (as identified by the user upon creation of the session). This information is transmitted via for example, a local network or an internet connection in step 38. Referring generally to step 40, the participants' devices receive the transmission, and a new web page for the session is created and loaded into each participant device. The devices then load the transmitted images, the web application code, and code configured to provide time synchronization. Finally, the devices download and store the uploaded data file, or the data file from a third party website. During the loading time of these assets, embodiments of the present disclosure may display a graphic indicative of this loading procedure, followed by a subsequent “Check In” button upon completion thereof. As set forth above, actuation of the “Check In” button confirms a user's desire to participate in the session, enabling the automatic execution of the downloaded data file at the predetermined execution time.

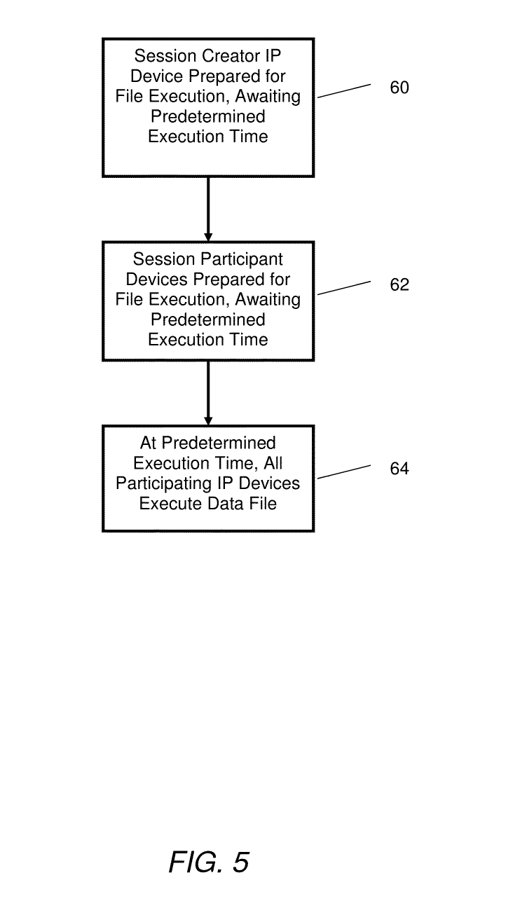

As illustrated in FIG. 5, once both the session creator's IP device (step 60), as well as the IP devices of each participant (step 62) have been loaded with the above-described assets, the creating user and participants need only to wait until the predetermined execution time arrives for the data file to be automatically executed by the code stored on each of the devices. In step 64, when the predetermined time arrives, each of the creating user and participant devices will execute, or play, the downloaded data file simultaneously.

FIG. 6 illustrates an exemplary process for accurately synchronizing each of the IP devices so as to ensure accurate temporal execution of the downloaded data file. It should be understood that the internal clock on each IP device may vary from device to device. One way to ensure synchronous execution of the data file is to instruct each IP device to reference a common clock, such as the clock of the session server, when timing the execution of the data file (step 42). This is achieved by, for example, instructing (via the downloaded executable code) each IP device to poll the session server for its clock time, and compare the polled session server clock time to the device's internal clock time (step 44). From this comparison, a time difference, or time offset, is generated which may be stored into the memory of the IP device. This stored offset is either added or subtracted from the time of the device's own internal clock in order to accurately reflect the time of the session server (step 46). In step 48, after each device has computed a corrected time indicative of the session server time, all of the devices are now synchronized. Therefore, when the predetermined execution time arrives, each of the IP devices execute the command instructions in unison. With respect to step 49, in order to ensure the accuracy of the synchronization, embodiments of the present disclosure may include additional instructions for commanding the IP devices to poll the session server, for example, once every second, or some other predetermined interval, and store each of these results into memory (e.g. store the ten most recent polling results). In another embodiment, the IP devices poll the session server once per second for a period of twenty seconds, and store these twenty polling results into memory. From these values, an average time offset may be calculated and used as the value to be added or subtracted from the internal clock of the device to achieve synchronization. This polling may be constantly performed until the time of execution is reached. In one embodiment, the session server utilizes the standard Network Time Protocol (NTP) for providing precise and accurate synchronization of the system clock of the session server, and each of the IP devices.

It should be understood that according to the above-described embodiments, the IP devices do not require a sustained network/internet connection once the session information and related executable code has been downloaded to each device, and the device has synchronized with the session server at least once. However, a continued internet connection may provided increased synchronization accuracy by virtue of the ability to continuously measure and store the offset time until the time of execution.

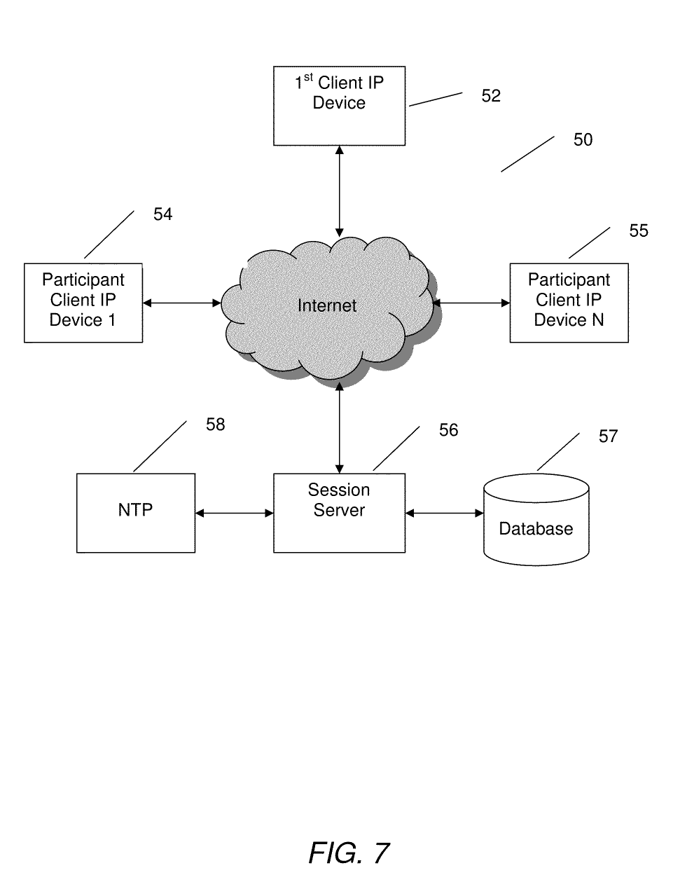

FIG. 7 is a block diagram illustrating an exemplary system 50 useful for describing embodiments of the present disclosure. System 50 includes, for example, a first or client IP device 52. IP device 52 may be used to create a session by, for example, accessing a web-based application running on a session server 56, or executing a native program existing on IP device 52. Session information, including a session name and a data file (e.g. an audio file) input by a user via device 52 may be stored on session database 57 for selective access by session server 56. Participant IP devices 54,55 (e.g. devices 1-N) may access session server 56 via, for example, an internet connection for downloading executable instructions and session information from the session database 57. These instructions may include, for example, instructions for executing the downloaded data file at the predetermined time, as well as instructions for synchronizing (and re-synchronizing) the IP device with the session server. As set forth above, session server 56 may utilize NTP 58 for synchronizing the clocks of the IP devices to that of the server.

While embodiments of the present disclosure have been described in the context of an application for playing, for example, an audio or video file, it should be understood that several other uses for the embodiments described herein have been contemplated. For example, embodiments of the present disclosure may be configured to provide for synchronous recording from a variety of input sources (e.g. microphones) associated with an IP device. Various multi-device communications, from an audio blast or a video blast to recording video from multi-perspectives at the same time to a multi-device microphone and/or karaoke application are encompassed herein.

The above-described illustrations are provided by way of example only, and other embodiments for implementing the synchronized file execution methods described herein may be contemplated by one of skill in the pertinent art without departing from the intended scope of this disclosure. The processes described herein may be performed by one or more computing systems (e.g. the above-described network devices and servers), including memory containing instructions, the instructions when executed by a processor, cause the steps of the disclosed methods for simultaneous file execution to be performed. The whole process or any part thereof, may be performed in hardware, software or any combination of hardware and/or software. Software may be embodied in a non-transitory machine readable medium upon which software instructions may be stored, the stored instructions when executed by a processor cause the processor to perform the above-described steps. Any suitable machine readable medium may be used, including but not limited to, magnetic or optical disks, for example CD-ROM, DVD-ROM, floppy disks and the like. Other media also fall within the intended scope of this disclosure, for example, dynamic random access memory (DRAM), random access memory (RAM), read-only memory (ROM) or flash memory may also be used.

While all or part of the methods according to embodiments of the present disclosure have been described as being performed by a user (e.g. a session creator and/or session participant(s)), it should be understood that many of these steps (e.g. uploading, downloading, storing, synchronizing, etc.) are performed by the above-described network devices under user control, and/or the described session servers.

While the foregoing invention has been described with reference to the above-described embodiment, various modifications and changes can be made without departing from the spirit of the invention. Accordingly, all such modifications and changes are considered to be within the scope of the appended claims. Accordingly, the specification and the drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations of variations of various embodiments. Combinations of the above embodiments, and other embodiments not specifically described herein, will be apparent to those of skill in the art upon reviewing the above description.

What is claimed is:

1. A method of synchronizing the execution of a data file by one or more network accessible devices comprising:
uploading a data file identifier via a network server to a database;
uploading a predetermined data file execution time to the database;
downloading the data file identifier via the network server from the database onto one or more network accessible devices;
downloading instructions for executing a data file associated with the data file identifier onto the one or more network accessible devices, the instructions including the predetermined data file execution time;
synchronizing the internal clock of the one or more network accessible devices to an internal clock of the server;
executing the data file on each of the one or more network accessible devices at the predetermined data file execution time.

2. The method of claim 1, wherein the data file identifier comprises a URL indicating the location of a data file.

3. The method of claim 1, wherein the steps of uploading the data file identifier via a network server to a database, and downloading the data file identifier via the network server from the database onto one or more network accessible devices includes uploading the data file via the network server to the database, and downloading the data file via the network server from the database onto the one or more network accessible devices.

4. The method of claim 1, wherein the steps of uploading a data file identifier and uploading a predetermined execution time to the database are achieved via a web-based application accessed by a network device.

5. The method of claim 4, further comprising the step of locating the data file identifier via a web search initiated by the web-based application.

6. The method of claim 1, further comprising the step of sending a URL to the one or more network accessible devices, the URL associated with a web-based application and the database for facilitating the steps of downloading the data file identifier and instructions for execution the data file.

7. The method of claim 1, wherein the step of synchronizing the internal clock of the one or more network accessible devices to an internal clock of the server comprises instructing each network accessible device to poll the server for its clock time, and comparing the polled server clock time to an internal clock time of the one or more devices.

8. The method of claim 7, further comprising the step of generating a time offset from the clock comparison, and storing the time offset in a memory of the one or more devices.

9. The method of claim 8, further comprising the step of adding or subtracting the stored time offset from the internal clock time of the one or more devices.

10. The method of claim 8, wherein the step of generating a time offset comprises generating a plurality of time offsets by polling the server for its clock time at a predetermined interval and storing the results of each poll into the memory of the one or more network devices.

11. The method of claim 10, further comprising the step of calculating an average time offset from the plurality of time offsets, and adding or subtracting the calculated average time offset from the internal clock time of the one or more devices.

12. The method of claim 10, wherein the step of generating a plurality of time offsets is continuously performed until the data file is executed at the predetermined time.

13. A non-transitory computer readable medium containing program instructions for causing a network accessible computer to perform the method of:
downloading a data file identifier via a network server from a database onto the computer;
downloading instructions for executing a data file associated with the data file identifier onto the computer;
synchronizing an internal clock of the computer to an internal clock of the server; and
executing the data file on the computer at a predetermined time indicated by the downloaded instructions.

14. The non-transitory computer readable medium of claim 13, wherein the data file identifier comprises a URL indicating the location of a data file.

15. The non-transitory computer readable medium of claim 13, wherein the step of downloading the data file identifier via a network server to the computer includes downloading the data file via the network server from the database onto the computer.

16. The non-transitory computer readable medium of claim 13, wherein the step of synchronizing the internal clock of the computer to an internal clock of the server comprises instructing the computer to poll the server for its clock time, and comparing the polled server clock time to the computer's internal clock time.

17. The non-transitory computer readable medium of claim 16, further comprising the step of generating a time offset from the clock comparison, and storing the time offset in a memory of the computer.

18. The non-transitory computer readable medium of claim 17, wherein the step of generating a time offset comprises generating a plurality of time offsets by polling the server for its clock time at a predetermined interval, and wherein the method further comprises:
storing the results of each poll into the memory of the computer;
calculating an average time offset from the plurality of time offsets, and adding or subtracting the calculated average time offset from the internal clock of the computer; and
continuously performing the steps of generating a plurality of time offsets and storing the results of each poll until the data file is executed at the predetermined time.

19. The non-transitory computer readable medium of claim 13, wherein the steps of downloading a data file identifier via a network server from a database onto the computer and downloading instructions for executing a data file associated with the data file identifier onto the computer are performed via a web-based application accessible by the computer.
